(19) United States
(12) Patent Application Publication
(10) Pub. No.: US 2009/0211475 A1
(43) Pub. Date: Aug. 27, 2009

(54) EXTENDED PRINT SLEEVE AND METHOD FOR PREPARING A PRINTING FORM FROM THE SLEEVE

(76) Inventor: BRADLEY K. TAYLOR, West Chester, PA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/035,063

(22) Filed: Feb. 21, 2008

(51) Int. Cl. B41F 13/08; B41C 3/00

(52) U.S. Cl. 101/375; 101/401.1

(57) ABSTRACT

The invention provides an extended print sleeve having a longitudinal axis and adapted to form a printing form having a circumferential seam with no printing surface disposed a distance D along said longitudinal axis from one end thereof, comprising: a first print element; and a second print element; wherein each print element comprises a separate cylindrically-shaped support having a photosensitive layer thereon and disposed at a fixed position along said longitudinal axis, and wherein said second print element has a length substantially equal to distance D.

### BACKGROUND OF THE INVENTION

1. Field of the Disclosure

This invention pertains to a print sleeve adapted to form a cylindrically-shaped printing form having a yielding surface for printing by rolling contact onto a substrate including a rough or yielding surface, and also a method for preparing the printing form.

2. Description of Related Art

Print sleeves (also known as printing sleeves) are used with print cylinders (also known as printing cylinders) to allow rapid and economical changes in the matter to be printed during print jobs by switching print sleeves, particularly flexographic print sleeves, without having to switch print cylinders. A large inventory of relatively inexpensive print sleeves can be made by print sleeve manufacturing equipment and methods, and rapidly placed on expensive print cylinders for printing, thereby increasing print cylinder utilization.

However, print sleeve manufacturing equipment can be inappropriate to make extended print sleeves beyond a certain axial length. For example, preparation of unimaged photosensitive print sleeves without axial welds may be limited due to length limitations in spindles or mandrels that are available or usable at a given printing location. For example, a print facility may have invested in spraying or extruding apparatus to make up to 2 meter wide unimaged relief-free flexographic photosensitive print sleeves for a 2 meter wide printing press, and later purchase a 4 meter wide printing press.

In order to overcome the problem of print cylinders significantly wider than available print sleeves in the prior art, two or more print sleeves have been placed onto a print cylinder; however each sleeve must be aligned separately for each job. There remains a need to simplify the use of multiple print sleeves on a print cylinder, particularly so that wide print sleeves and fixed-position multiple print sleeves can be easily produced and used efficiently.

U.S. Pat. No. 5,551,339 to Schadlich et al., issued Sep. 3, 1996, entitled “Process and device for register-correct positioning of printing form sleeves” discloses a process and a device for register-correct positioning of printing form sleeves on printing cylinders of a rotary printing machine, each with a pressure gas cushion producible for shifting the elastically expandable printing form sleeve on the printing form cylinder.

U.S. Pat. No. 5,379,693 to Hoffmann et al., issued Jan. 10, 1995, entitled “Welded tubular printing plate, and the method of making” discloses a printing plate made of metallic material, wherein the leading and trailing edges of the printing plate, after having been cut to size, are so connected that the offset printing plate is formed into a circumferentially continuous tube or sleeve. This tube or sleeve is fitted on a printing machine cylinder in such a way that it is frictionally engaged for printing, yet can be released from the printing cylinder.

U.S. Pat. No. 5,798,019 to Cushner et al., issued Aug. 25, 1998, entitled “Methods and apparatus for forming cylindrical photosensitive elements”, discloses methods and apparatus for forming seamless cylindrical photosensitive elements of uniform thickness on flexible sleeves. The seamless cylindrical photosensitive elements are formed on polyester sleeves for use on a printing cylinder.

U.S. Pat. No. 5,778,779 to Jones et al., issued Jul. 14, 1998, entitled “Printing unit and register mechanism for mounting a printing sleeve”, discloses in the FIGS. 5, 6, and 7 therein that two or more printing forms may be mounted on a single print cylinder.

EP510744 to Patten et al. issued Oct. 28, 1992, entitled “Apparatus Relating to a Printing Unit”, discloses an apparatus relating to a printing unit including a printing roll which comprises a printing roll core and one or a plurality of printing sleeves carrying the pattern to be printed, which printing sleeves can be mounted on the core from one end thereof and be displaced along and turned around the core to and from a number of register positions on the core.

U.S. Pat. No. 7,107,907 to Vrotacoe, issued Sep. 19, 2006, entitled “Flow-restricted printing cylinder for a removable printing sleeve” discloses a printing cylinder that can accommodate the fluid-assisted removal or placement of more than one printing sleeve. Also disclosed is the fluid-assisted removal or placement of a printing sleeve.

U.S. Pat. No. 7,041,432 to Markhart, issued May 9, 2006, entitled “Apparatus and method for thermally developing flexographic printing elements”, discloses thermal development apparatus and a method of using the thermal development apparatus to remove uncured photopolymer from the imaged surface of a flexographic printing element. Also disclosed is an apparatus and a method of use that can accomplish both exposing and development steps, to both expose the flexographic printing element to actinic radiation and to remove uncured photopolymer from the imaged surface of the flexographic printing element.

### SUMMARY OF THE INVENTION

The present invention provides an extended print sleeve having a longitudinal axis and adapted to form a printing form having a circumferential seam with no printing surface disposed a distance D along said axis from one end thereof, comprising: a first print element; and a second print element; wherein each print element comprises a separate cylindrically-shaped support having a photosensitive layer thereon and disposed at a fixed position along said axis, and wherein said second print element has a length substantially equal to distance D.

The present invention also provides a method for preparing a cylindrically-shaped printing form having a longitudinal axis and a circumferential seam with no printing surface disposed a distance D along said axis from one end thereof comprising: providing an extended print sleeve comprising: a first print element; and a second print element; wherein each print element comprises a separate cylindrically-shaped support having a photosensitive layer thereon and disposed at a fixed position along said axis, wherein said second print element has a length substantially equal to distance D, and wherein each photosensitive layer comprises a binder, a monomer and a photoinitiator; exposing the extended print sleeve to actinic radiation; and treating the exposed extended print sleeve to form a relief surface suitable for printing.

### BRIEF DESCRIPTION OF THE DRAWINGS

FIG. 1A is a perspective view of a known cylindrically-shaped support.

FIG. 1B is a perspective view of a print sleeve before generation of a relief surface.

FIG. 2A is a perspective view of one embodiment of an extended print sleeve comprising a base support sleeve supporting two print elements.

FIG. 2B is a cross-sectional view taken along line 2B of FIG. 2A.

FIG. 3A is a perspective view of one embodiment of an extended print sleeve comprising two print elements fastened together.

FIG. 3B is a cross-sectional view taken along line 3B of FIG. 3A.

### DESCRIPTION OF THE PREFERRED EMBODIMENT(S)

Throughout the following detailed description, similar reference characters refer to similar elements in all Figures of the drawings.

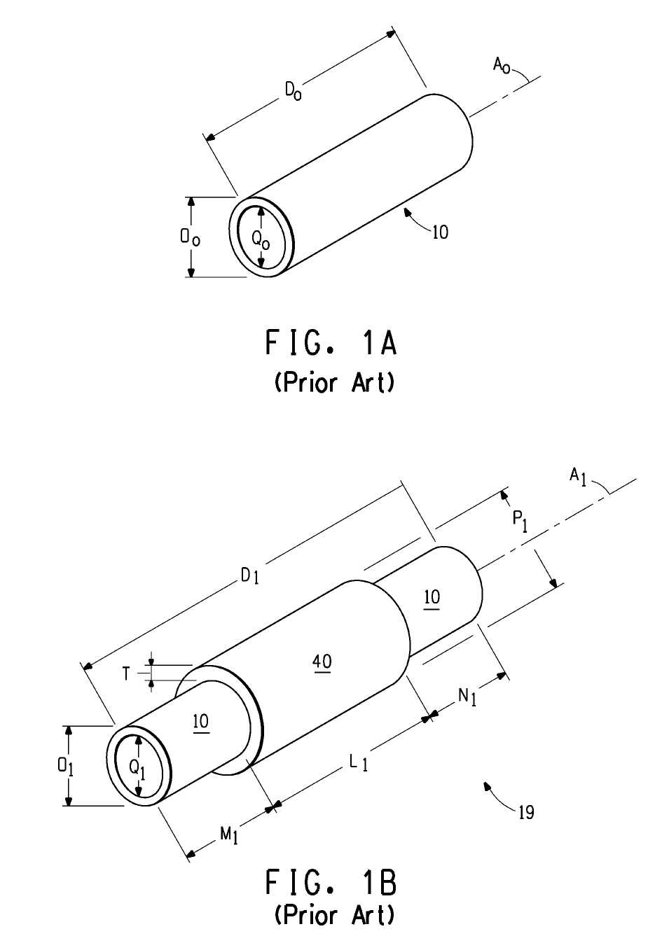

FIGS. 1A and 1B show a cylindrically-shaped support 10 and a print sleeve 19 before imaging and production of a relief for use as a printing form in printing image(s) on a rotary press. FIG. 1A shows a cylindrically-shaped support 10 designed to fit immovably upon a print cylinder (not shown) during printing. The cylindrically-shaped support 10 is capable of supporting a relief surface derived from photosensitive layer 40, the combination of such with other optional components being called a printing form. The printing form comprising the cylindrically-shaped support 10 is capable of transferring ink according to a desired image to a substrate, while optionally aligned with one or more other printing forms transferring the same or other inks to the substrate, to form for example a multicolored printed substrate suitable for use as product packaging.

The cylindrically-shaped support 10 typically includes the innermost surface of a print sleeve 19 and serves to hold other layers or elements in place on the final print form (either directly or indirectly), providing a rigidity sufficient for handling and use of the form. The cylindrically-shaped support 10 is made so as to fit over the print cylinder of a rotary printing press, optionally while having a mandrel or bridge or repeat modifiers interposed between the cylindrically-shaped support 10 and the print cylinder. Any mandrel or bridge or repeat modifiers act to increase the diameter of the print cylinder so that with the print form the desired print diameter and circumferential repeat distance are reached. Each part needs to fit securely to neighboring parts.

The cylindrically-shaped support 10 is hollow, and may be so thin as to deform away from a circular internal cross section, but is typically deformable so as to assume a circular internal cross section having a longitudinal axis A₀ (the longitudinal axis being coaxial with the axis of rotational symmetry of the cylinder, and extending from one end of the cylinder to the other).

Typically to a close approximation each circular cross section has an inner diameter Q₀ passing through the longitudinal axis A₀. The cylindrically-shaped support 10 typically has an outer surface of circular cross section concentric to the circular internal cross section, having an outer diameter O₀ greater than Q₀. This symmetry is important to allow mounting on a print cylinder. The cylindrically-shaped support 10 has a length D₀, the longest measured along the longitudinal axis A₀ such that a perpendicular of A₀ intersects the cylindrically-shaped support 10.

The cylindrically-shaped support 10 is typically expandable in circular internal cross section so as to allow an interference fit with a print cylinder having an outside diameter slightly greater than Q₀ at ambient temperature. Suitable expansion means includes forced or pressurized air, or forced or pressurized fluid, introduced from the print cylinder between the print cylinder and the cylindrically-shaped support 10. Another suitable expansion means is relative heating of the cylindrically-shaped support 10 to bring about expansion. Other conventional means can be used.

In the present invention, an interference fit is a term used in the ordinary manner, analogously to a press fit. For example, where two parts have dimensions prior to fastening which show they will occupy at least some portion of the same space after fastening, and they avoid occupying the same space by compressive and tensile movement rather than just plastic flow or breaking, they achieve an interference fit. In practice, after fastening by the interference fit at least one of the parts deforms where in contact with the other part, and at least one region of high friction between the two parts is created where they are in contact. The region of high friction tends to keep the parts in one alignment. A common example in addition to print sleeves over print cylinders is insertion of an axle into a railroad train wheel.

One way to obtain an interference fit is that air pressure can be used to expand the cylindrically-shaped support 10 of a printing form slightly, thus allowing it to be slid over a print cylinder on a cushion of air. Once the supply of air pressure is stopped, the cylindrically-shaped support 10 shrinks so that it is held tightly in place on the print cylinder, thus holding the entire printing form in the printing position. Other well known methods can be used to fix the print sleeve 19 to a print cylinder (usually temporarily).

Typical materials used in the cylindrically-shaped support 10 are nickel (e.g. a seamless nickel print base), other metals (e.g. copper, steel), polyester (e.g. polyester terephthalate), fiberglass, composites, multilayer composites, or some other conventional material. The cylindrically-shaped support 10 can have a wall thickness of 0.005 cm or less to 2.5 cm or more, typically 0.013 cm to 0.64 cm for metals, and 0.025 cm to 0.127 cm for fiberglass, and 0.025 cm to 2.5 cm for other composites.

The cylindrically-shaped support material is typically chosen to have sufficient rigidity for handling, possibly combined with a small degree of elasticity (appropriate Young's modulus) to allow an interference fit to a print cylinder.

In one embodiment of the invention, as is common in the known art, the cylindrically-shaped support is very slightly tapered in inner diameter along the longitudinal axis so as to improve the fit of a print form to a print cylinder. In the present invention, the term cylindrically-shaped support includes such slightly modified cylinders (as when the tapering is equivalent to less than 2%, preferably less than 1%, more preferably less than 0.5%, even more preferably less than 0.1% of the inner diameter over an axial length of 100 mm of the support).

FIG. 1B shows a print sleeve 19 comprising a cylindrically-shaped support 10 having a photosensitive layer 40 thereupon (affixed to or adjacent an outside surface of the cylindrically-shaped support 10). In this known embodiment, the print sleeve 19 has a longitudinal axis A₁ and length D₁ along that longitudinal axis, an inner diameter Q₁ passing through the longitudinal axis A₁ and consistent with affixing the print sleeve 19 to a print cylinder, and an outer diameter O₁ consistent with supporting the photosensitive layer 40 for formation of a relief surface suitable for printing with an appropriate repeat distance. Each of the two ends of the hollow print sleeve 19 is capable of allowing a print cylinder to pass through and allow for securing the print sleeve 19 to the print cylinder.

The cylindrically-shaped support 10 is characterized by a single length D₁ due to both ends being circular and perpendicular to the longitudinal axis, while in other embodiments the ends can be elliptical or a three dimensional closed curve. In such cases, the length of the print sleeve is considered to be the distance D of the longest longitudinal axis having a portion of the print sleeve at right angles to the longitudinal axis. This is equivalent to the length of a right angle box holding the print sleeve, being of minimum length parallel to the longitudinal axis. A cylindrically-shaped support can depart from being a perfect cylinder by virtue of holes for fasteners or gas flow, channels to engage pins for alignment, notches, cuts in the edge for encoding information, or other reasons known in the art.

The photosensitive layer 40 affixed to the outer surface of the cylindrically-shaped support 10 has an axial length L₁ parallel to the longitudinal axis A₁, an outer diameter P₁, and a thickness T giving the photosensitive layer a typically concentric placement adjacent and outside the cylindrically-shaped support 10.

In the present invention, a photosensitive layer 40 is a layer that is conventional and interacts with actinic light, laser light, or radiation (e.g. of ultraviolet, visible, or infrared wavelengths) in a way that leads to creation or definition of a relief surface for printing. Two possible interactions include direct removal of material or differentiation of irradiated areas from unirradiated areas that is exploited to preferentially remove one of the two areas. In one embodiment sometimes termed laser engraving, a photosensitive layer 40 can be directly image-wise removed by a laser. This treatment is one that can be combined with a previous overall exposing to form a polymerized photosensitive layer of more suitable properties for treatment to form a relief surface (e.g. hardness, toughness, elasticity, etc.).

In another embodiment, sometimes termed laser ablation, the photosensitive layer 40 can be covered by an infrared-ablatable actinic-radiation-blocking layer that is ablated by image-wise exposure to infrared laser radiation, to form an in-situ mask for actinic-radiation exposure of the photosensitive layer. The mask can be used for imagewise exposure of the photosensitive layer 40 to a blanket exposure of actinic light partially blocked by the blocking layer. A preferred actinic radiation is ultraviolet radiation. The blanket exposure masked by the in-situ mask can serve to make the exposed photosensitive layer resistant to removal by thermal treatment or by wash-out. Other methods of forming a mask on the photosensitive layer 40 are contemplated as well, including inkjet application, thermal transfer from a donor by a laser, and lamination.

Another embodiment for imagewise exposing uses a conventional, separate photomask that is positioned over the photosensitive layer 40 in an otherwise analogous method to the in-situ mask method of forming a differentiation of irradiated areas and unirradiated areas.

In thermal treatment, the photosensitive layer 40 is typically heated and the less exposed and unexposed photosensitive layer is wicked or wiped away by an absorbent material, while more exposed regions of the photosensitive layer remain behind due to crosslinking, high molecular weight, or other properties. The heating causes unpolymerized photosensitive layer portions to melt, flow, or soften, typically more so than polymerized portions. Removal of the melted, softened, or low-viscosity portions can be accomplished by conventional methods such as wiping.

In treatment by a wash-out mixture, solution, dispersion, or emulsion, the photosensitive layer is washed by solvent-based, water-based, or aqueous-base-washout liquids that wash-off the less exposed and unexposed photosensitive layer in comparison to exposed and polymerized areas.

In certain embodiments, the photosensitive layer 40 comprises one or more binders, or one or more polymers, or one or more oligomers, or one or more monomers, or one or more cross-linkers, or one or more solvents, or one or more photoinitiators, or one or more kinds of particles, or combinations thereof.

In certain embodiments, one or more non-photosensitive layers may be found between the cylindrically-shaped support 10 and the photosensitive layer 40, or covering the photosensitive layer 40. Before at least portions of the photosensitive layer 40 are photopolymerized or removed, the print sleeve 19 can be termed a blank, blank print sleeve, blank printing sleeve, blank printing form, blank print form, etc.

The photosensitive layer 40 of FIG. 1B has of a thickness T, from a point outside the cylindrically-shaped support 10 to the outside surface of the print sleeve 19. In a common embodiment, the thickness T is basically the same composition throughout the area of the photosensitive layer 40 prior to treatment, but multiple compositions are also well known, such as those produced by partial polymerization producing crosslinked layers on the side near the cylindrically-shaped support 10. The outside surface of the photosensitive layer 40 can be smooth, rough, scalloped, or otherwise variable so as to eventually facilitate ink transfer from the print sleeve to the substrate being printed or for other purposes. In FIG. 1B, the photosensitive layer 40 is not a photodefined relief surface; but the photosensitive layer 40 can be treated to give such a relief surface suitable for printing by the conventional methods described herein such as exposure to actinic radiation through a mask and treatment.

The present invention includes an extended print sleeve having a longitudinal axis and adapted to form a printing form having a circumferential seam with no printing surface disposed a distance D along said longitudinal axis from one end thereof, comprising: a first print element; and a second print element; wherein each print element comprises a separate cylindrically-shaped support having a photosensitive layer thereon and disposed at a fixed position along said longitudinal axis, and wherein said second print element has a length substantially equal to distance D. The first print element and second print element may be held in a fixed relationship by attachment of each to another element such as a base support sleeve, or by attachment of one print element to the other, or by any other method.

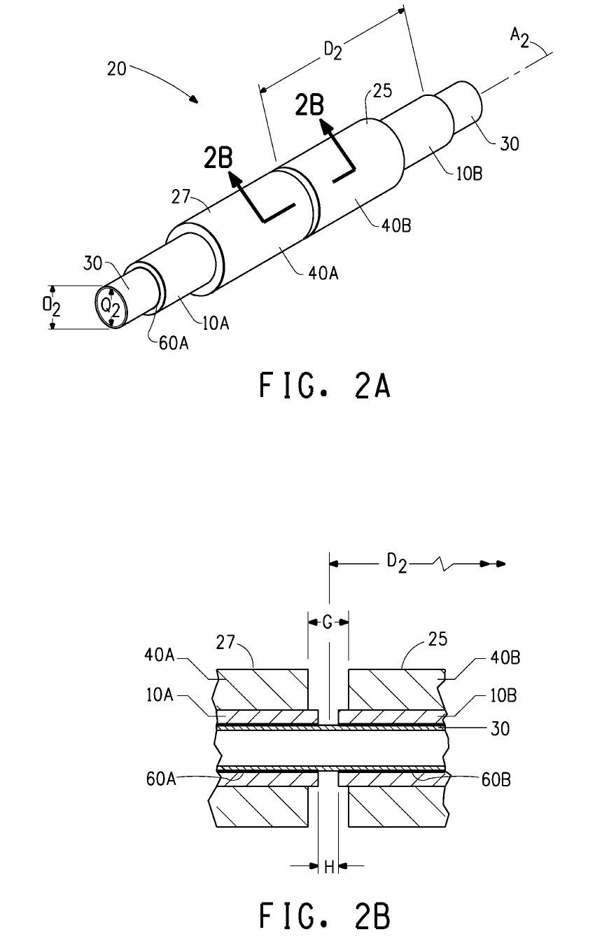

FIGS. 2A and 2B show an extended print sleeve of the present invention comprising two or more print elements each separately capable of transformation into a printing form useful for printing on a print cylinder of a rotary press, which are fixed relative to one another so as to form an axially longer printing form useful for printing a wider pattern onto a substrate. FIGS. 2A and 2B show an embodiment of an extended print sleeve 20 comprising a base support sleeve 30 concentrically disposed around a longitudinal axis A₂. The base support sleeve 30 has an inner diameter Q₂ appropriate for mounting onto a print cylinder, and outer diameter O₂. The base support sleeve 30 has fastened to it a first print element 27 and a second print element 25, each print element 25 and 27 comprising a separate cylindrically-shaped support 10A, 10B having a photosensitive layer 40A, 40B thereon (coextensive, adjacent, and basically concentric to, but not necessarily contacting the base sleeve support). Another layer or layers such as an adhesive layer can be found between the cylindrically-shaped support 10 and the photosensitive layer 40.

Every photosensitive layer of the present invention is capable of providing or supporting a printing surface. The printing surface is capable of holding ink and transferring ink to a substrate such as paper momentarily brought into contact with the ink by means of rotation of a print cylinder and coordinated translation of the substrate. Printing a pattern rather than the complete surface area of the original photosensitive layer is made possible by selective treatment of the photosensitive layer so as to form a relief surface of raised and recessed portions. In one embodiment, recessed portions, where some or all of the photosensitive layer is removed, are properly spaced to not allow contact of any ink with the substrate (flexographic printing being an example).

In FIG. 2A, the front most, leftward first print element 27 comprises a cylindrically-shaped support 10A supporting a photosensitive layer 40A thereupon, the cylindrically-shaped support 10A with an inner diameter slightly more than O₂, fastened to the base support sleeve 30 by an adhesive 60A disposed between the inner surface of the cylindrically-shaped support 10A and the outer surface of the base support sleeve 30. The rearmost, rightward second print element 25 (also fastened to the base support sleeve 30) comprises a cylindrically-shaped support 10B supporting a photosensitive layer 40B thereupon, the cylindrically-shaped support 10B of nominal outer diameter less than O₂ held securely by an interference fit to the base support sleeve 30, separately and out of contact from the print element 27.

When the two adjacent print elements 25 and 27 are out of contact from one another at all points (e.g. not interference fitted to one another, not welded together, not touching, etc.) but are held rigidly with respect to one another by fastening to at least one separate element such as a base support sleeve 30, the print elements are spatially separated from each other. Alternatively, when portions of the print elements 25 and 27 such as the second print element 25 cylindrically-shaped support 10B and the first print element 27 cylindrically-shaped support 10A are welded together, or fastened together by an interference fit, or touching, etc. the print elements are contacting or in contact.

The photosensitive layer 40A of the print first element 27 is separated from the photosensitive layer 40B of the second print element 25 by a separation gap G as shown in FIG. 2B. This separation gap G is found at a distance D₂ from the rightmost end of the extended print sleeve 20.

FIG. 2B shows a positive separation H keeping the two cylindrically-shaped supports 10A and 10B of the print elements 27 and 25, respectively, out of contact; this lack of contact persists around the entire circumference of the extended print sleeve 20. Also shown is the positive separation gap G keeping the two photosensitive layers 40A and 40B out of contact; likewise around the entire perimeter. That separation gap G defines a circumferential seam with no printing surface provided by any photosensitive layer at a height appropriate to form a relief surface, at least a portion of which is disposed a distance D₂ along the longitudinal axis from one end of the extended printing sleeve. The fastening of each print element 27 and 25 to the base support sleeve 30 keeps each element aligned with respect to one another both rotationally and by separation (the relative time and relative separation at which each prints on the rotary press will only depend on the rate of rotation).

In the embodiment shown, the first print element 27 is held in place by adhesive 60A bonding it to base support sleeve 30, and the second print element 25 is held in place by an interference fit 60B to base support sleeve 30. The gap represents an area on the extended print sleeve that is not capable of printing. In this embodiment, the gap is between two areas that are capable of printing. The gap exists at a distance D₂ from the rightmost end of the print element 25, and extends a distance G including the location at a distance D₂ from the rightmost end of the print element 25. In actual practice, the unprintable region can be calculated to extend a distance from each end of the gap to account for uncertainties in alignment, placement, print quality, etc.

This embodiment shows two print elements, one fastened to a base support sleeve by an adhesive, and the other by an interference fit. It is also possible to make an embodiment with two or more individual print elements all fastened by interference fits or all fastened by adhesive, or fastened by other conventional methods individually or groupwise.

In the context of the present invention, fastening conveys an attachment of two or more parts that may be direct (e.g. an interference fit, rivets) or indirect (e.g. adhesive applied concentrically that separates the base support sleeve from a print element); and of any amount of permanence (reversible or irreversible). In a preferred embodiment, the fastening of the print elements to the base support sleeve is not unfastened between printing jobs. A print cylinder (providing at least one of rotational movement to the extended print sleeve, or alignment of an attached extended print sleeve to another print sleeve attached to another print cylinder) is not contemplated as a base support sleeve.

Extended print sleeves are typically composed of thin layers and are thin overall while maintaining useful dimensional stability; for example the thickness of an extended print sleeve from the outermost surface of any photosensitive layer to the innermost surface of the extended print sleeve at the cylindrically shaped support or base support layer may be less than at least one of 4 cm, 2 cm, 1 cm, 5 mm, 2 mm, 1 mm, 500 nm, 250 nm, 120 nm, or 60 nm.

FIGS. 2A and 2B illustrate that in an embodiment of the invention, neither the beginning nor the end of the width of a circumferential seam with no printing surface is necessarily at a distance along the longitudinal axis coaxial with the length of a print element, even for (extended) print elements having circular ends; however the length of the print element gives a distance D within the circumferential seam at one or more points on the outer surface of the extended print sleeve. This can also be true when the extended print sleeve or one or more of its constituent print elements do not have two circular ends (e.g. elliptical ends or complex closed curve ends). Due to the complexities of how the extended print element is configured, in certain embodiments an extended print sleeve having a longitudinal axis and adapted to form a printing form can be an embodiment of the invention. The extended print sleeve has a circumferential seam with no printing surface disposed a distance D₂ along said longitudinal axis from one end of the extended print sleeve. The extended print sleeve comprises a first print element; and a second print element; wherein each print element comprises a separate cylindrically-shaped support having a photosensitive layer thereon and disposed in a fixed position along said longitudinal axis. The second print element has a length substantially equal to distance D, where substantially equal means within 90% of equal (e.g. 90.0001 mm is substantially equal to 100 mm). In other embodiments, substantially equal means (in this context and others of the invention) within one of 95, 96, 97, 98, 99, 99.5, 99.8, 99.9, and 99.99% of equal.

In one embodiment, the base support sleeve can be a cylindrically-shaped support, for example as in FIG. 1A. Both the cylindrically-shaped support and the base support sleeve have many similar physical requirements, since both the cylindrically-shaped support and the base support sleeve can be suitable for removable mounting on a print cylinder; thus for example a material of construction such as nickel or polyethylene terephthalate can be appropriate.

In the embodiment illustrated in FIGS. 2A and 2B, the first print element secured to the base support sleeve is disposed in a fixed position along the longitudinal axis relative to the second print element by means of the adhesive securing the first print element to the base support sleeve, and an interference fit of the second print element to the same base support sleeve, and the relative rigidity of the base support sleeve. This tactic of fastening each print element to a single base support sleeve can also be carried out with the fastening alternatively or additionally being comprised of materials and techniques conventionally used to fasten a print sleeve to a print cylinder, for example hot melt adhesives, thermoset adhesives, an interference fit, mechanical fasteners such as a hook and eye, a rivet, a pin through one or more holes or into a slot, a notch, VELCRO® brand hook and loop fastener or other types of fastening fabric, or welds such as laser welds.

As is apparent to one skilled in the art, these methods of fastening can preferably be disposed so as not to interfere with printing or placement on a print cylinder. In some cases the print cylinder or method of printing such as the area printed may be adapted to account for the method of fastening.

Various types of hot melt adhesives are available for use for the purposes of the invention. Examples are ethylene-vinyl acetate (EVA) copolymer, polyamide, polyester, polyethylene, polypropylene, epoxy-phenolic, styrene-butadiene rubber, and other synthetic rubbers.

Welds suitable to the present invention are possible by adapting the methods of U.S. Pat. No. 5,379,693 to Hoffmann et al., issued Jan. 10, 1995, entitled “Welded tubular printing plate, and the method of making”, while operating to produce a circumferential weld rather than a weld parallel to the longitudinal axis, or by other conventional welding techniques. The welds (or other fastenings) need not be continuous, but should be extensive enough to allow for keeping the print elements aligned for two or more uses with, and one or more removals from, a print cylinder.

Various types of thermoset adhesives are available for use for the purposes of the invention, for example polyvinyls, acrylics, polyurethanes, polyolefins, and thermoplastic esters.

One advantage in fastening two blank print elements together prior to forming a relief-containing printing form is that the alignment of each section of the final printing form contributed by each print element remains the same to the other regardless of how many times the printing form is applied and removed from the print cylinder; whereas if the two blank print elements were converted to separate printing forms as found in the known art, and then fastened, each would need to be separately aligned to the printing forms of other colors or to one another. Therefore the number of alignments can be cut in half in certain embodiments of the present invention. The gap in the presence of photosensitive layer and ultimately the relief pattern can be compensated for by placing a section not needing inking at that position of the substrate being printed, such as the vertical fold of a newspaper, the binding of a book, or the edge of a roll of wrapping paper when printing a single substrate to be slit into multiple rolls of wrapping paper, etc.

Well known methods for mounting sleeves in the printing industry can be adapted to provide the embodiment shown having two print elements fastened to a base support sleeve. For example, U.S. Pat. No. 4,461,663 to Tachibana et al., issued Jul. 24, 1984, entitled “Method of mounting a removable printing sleeve on a core utilizing a hot melt adhesive” details fitting a printing sleeve over a core roll with a layer of hot melt adhesive between—in one variation, the concentric hollow printing sleeve is slid concentrically over the heated core roll bearing molten hot melt adhesive. This method can be adapted by replacing the gravure sleeve by a print element, the core roll by a base support sleeve, and by carrying out the placement of print elements twice rather than once. Removable stops (e.g., pins in holes) can be affixed to the base support sleeve or spacers to the print elements (e.g. to achieve spacing of the first print element from the second print element). It is unimportant to later remove the printing elements, so a thermosetting adhesive is also appropriate to an embodiment of the present invention in place of a hot melt adhesive, removing the need for heating to allow flow of a hot melt adhesive.

In one embodiment the extended print sleeve has a gap such as G that defines the location of a circumferential seam lacking a suitable amount of photosensitive layer to form a relief surface for printing. The circumferential seam of the invention extends entirely around the extended print sleeve, and consequently the unprintable region extends entirely down the substrate to be printed as an extended printing form derived from the extended print sleeve rotates numerous times on a print cylinder. The circumferential seam may be a simple, symmetrical ring, providing an unprintable stripe with straight edges, or the seam may have complex circumferential boundaries that produce an unprintable region with one or more of straight or other edges (e.g. resembling a sine wave, saw tooth, squiggle, or other non-linear boundary). The width of the unprintable area can vary (by position on a single sleeve, or between different extended print sleeves); in one embodiment the maximum width can be from 0.1 mm to 5 cm or more; for example from 0.1 to 2 mm, 1 to 5 mm, 2 to 10 mm, or 1 to 5 cm.

In one embodiment, the average depth of the gap producing the unprintable area in the circumferential seam can be within a factor of 1 to 10 (equal to or) smaller than the photosensitive layer; e.g. for a photosensitive layer of 2 mm thick, the average depth of the gap may be 1, 2, 5, or 10 fold smaller, corresponding to 2 mm, 1 mm, 0.04 mm, and 0.02 mm. In another embodiment, the gap can be deeper than the photosensitive layer thickness, for example when the gap depth also encompasses the absence of cylindrically-shaped support.

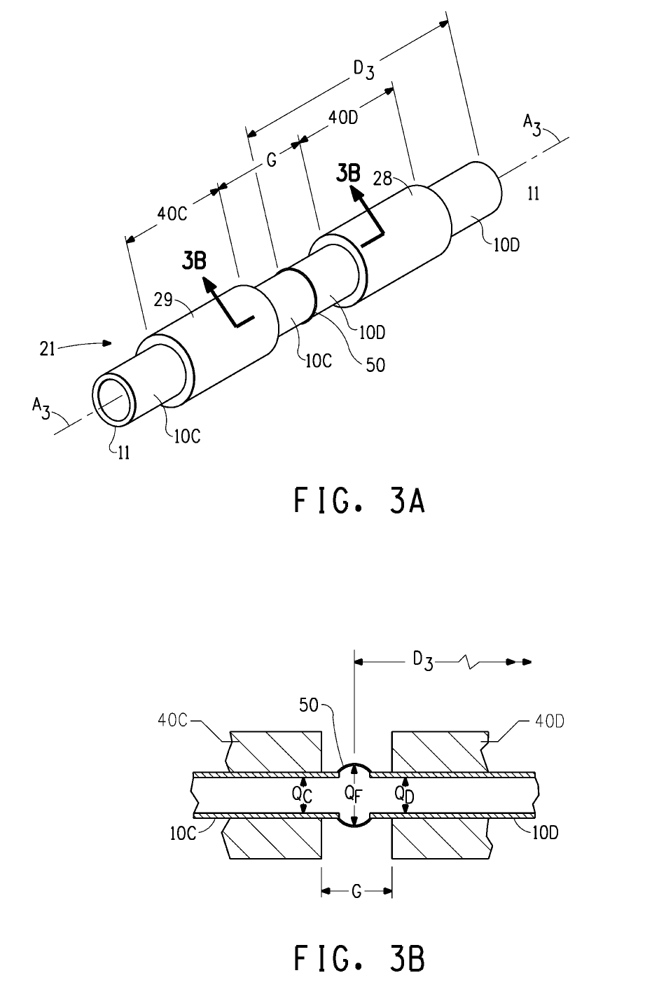

FIGS. 3A and 3B show an extended print sleeve 21 embodying the invention wherein two print elements are contacting and fixed in position end to end along their longitudinal axes (with their axes collinear). The extended print sleeve 21 comprises a fastening 50 (more specifically illustrated as a weld) that joins two print elements (28, 29). No base support sleeve is present in FIGS. 3A and 3B; the first print element 29 is joined at one end thereof to an end of the second print element 28. In this embodiment, the joining is illustrated as a weld; however other joining could be made, for example by adhesive (particularly a thermoset adhesive such as an epoxy), or by an interference fit of one end of the first print element over one end of the second print element. In other embodiments, the joining can occur at any layers or components of one print element to another; e.g. the end of a cylindrically-shaped support to the end of a second cylindrically-shaped support, the end of a cylindrically-shaped support to the end of a photosensitive layer not supported by that cylindrically-shaped support, the end of a photosensitive layer to the end of a second photosensitive layer, etc.

FIG. 3A shows a portion of the extended print sleeve 21 comprising a fastening 50 between two sections of cylindrically-shaped support 10C and 10D. The close cylindrically-shaped support 10C supports a photosensitive layer 40C analogously to FIG. 1B. The far cylindrically-shaped support 10D supports a photosensitive layer 40D analogously to FIG. 1B, on the outside convex surface of the cylindrically-shaped support 10D. The fastening 50 between the two supports joins the close cylindrically-shaped support 10C with the far cylindrically-shaped support 10D, end to end, such that the axes of rotation of both supports are collinear, giving an extended cylindrically-shaped support structure 11 having at least one obvious discontinuity (the fastening) at an approximate distance D₃ from the far (distal) end of the extended cylindrically-shaped support 11. This embodiment is preferred over an embodiment where the axes of rotation of both supports are not collinear.

For each print element of an extended print sleeve, an end of the print element is defined conventionally as an extreme and last circumferential continuous region of the print element perpendicular to the longitudinal axis. The first and second print element each have two ends, one of which is closer to the other print element in the extended print sleeve—which end will be termed the “close end”. Joining can be carried out at these close ends using the techniques described herein (e.g. welding, adhesive bonding, interference fit) and others well known in the art.

In various embodiments of the invention, the joining of print elements to one another or to a base support sleeve need not be continuous around the circumference of the print sleeve, but can be discontinuous. For example, either a continuous circumferential weld or a nearly circumferential weld or a plurality of spot welds are all contemplated; as is a continuous or discontinuous application of adhesive to a base support sleeve, so long as alignment of the print elements can be maintained.

The near photosensitive layer 40C can be photodefined and converted to a relief structure on the extended printing form derived from the extended printing sleeve. The far photosensitive layer 40D can be photodefined and converted to a relief structure on the extended printing form derived from the extended printing sleeve. Separating those two photodefinable, relief-capable portions of photosensitive layer is a gap of distance G in width, typically including the fastening 50, which will not be available for photodefinition, relief generation, and printing, wherein the distance D₃ falls within the ring-like gap of circumferential width G having photosensitive layer on both sides. The gap is separated from an end of the extended print sleeve by a distance D₃, including a photosensitive layer and any layers extended beyond the photosensitive layer such as cylindrically-shaped support and any other optional layers. The analogous relationship exists in FIGS. 2A and 2B.

In FIG. 3B the fastening 50 (more specifically illustrated as a weld) is seen to have an inner diameter Q_{F} greater than or equal to the inner diameter of the cylindrically-shaped support Q_{C} and the inner diameter of the far cylindrically-shaped support Q_{D}, while Q_{C} is equal to Q_{D}. This embodiment is preferred to those with either Q_{C} not equal to Q_{D}, or with the fastening inner diameter Q_{F} less than at least one of Q_{C} or Q_{D}, since the latter inequalities can complicate the placement of the extended print sleeve 21 onto a print cylinder.

In certain embodiments, each extended print sleeve 20, 21 (after conversion to a printing form having a relief) are individually used in flexographic printing on a printing job requiring only one printing form. In most embodiments, flexographic printing is carried out with the converted (relief-surface-bearing) extended print sleeve on the print cylinder of a rotary printing press being immovably held relative to the cylinder. Rotation of the print cylinder and extended print sleeve can ink the extended print sleeve (for example using an anilox roller) on the highest portions of the flexible relief surface of the converted extended print sleeve, then rotate the flexible relief surface into contact with the (possibly soft or flexible) substrate printed upon to produce an inked mirror image of the relief surface of the converted extended print sleeve on the substrate. The inking (as needed) and printing rotation is carried out continuously as substrate is fed past, for many rotations that can be carried out at high speed. Suitable substrates for printing upon include labels, tape, bags, boxes, banners, paper, newsprint, films, flexible films, etc. The printed product can have numerous identical of different discrete or joined images, possibly repeated, not longer than the outer circumference of the extended print sleeve relief surface, such as for example a newspaper page printed with a single rotation; or packaging where a discrete number (possibly one) of package sides are printed in a single rotation; or a continuous image printing much longer than the outer circumference of the extended print sleeve relief surface, such as for example wallpaper or wrapping paper which may run 1000 meters from a 1 meter circumference relief.

In one embodiment, the extended print sleeve of the present invention can be seen to include at least two formerly separate print sleeves or elements joined together to enable printing a larger width than either print sleeve can individually cover, from a print cylinder of a larger width than either print sleeve. The extended print sleeve is compatible with photochemically forming the relief on the sleeve. This extended print sleeve has an unprintable gap within the larger width printed due to the method used to join the formerly separate print sleeves, and each of the formerly separate elements is held in alignment to one another.

In the present invention, the term “printing form” refers to an element capable, or transformable to an element capable, of flexographic printing as a print cylinder of a rotary printing press. For example, an unimaged printing form will be transformable for printing a pattern after photoexposure and other steps necessary to form a relief. A necessary step of printing using an extended print sleeve of the present invention is to form reliefs using the at least two photosensitive layers of the extended print sleeve (the invention contemplates extended print sleeves with more than one circumferential gap formed by more than two print elements).

In one embodiment, the extended print sleeve includes a photosensitive layer comprising a binder, a monomer, and a photoinitiator. Other ingredients may also be present, including solvents, cross-linkers, etc. Methods commonly used to position a photosensitive layer outside a cylindrically-shaped support can be used to form the print elements. Other layers may intervene between the cylindrically-shaped support and the photosensitive layer, and the photosensitive layer need not be the outermost layer.

Photosensitive layer thickness is conventional; it may include 0.05 to 7 grams photosensitive layer per square meter of cylindrically-shaped support, or may constitute thickness from 0.05 mm to 15 mm. Suitable conventional methods of application are known from U.S. Pat. No. 4,883,742 to Wallbillitch et al., issued Nov. 28, 1989, entitled “Seamless and firm joining of the end and/or lateral areas of photosensitive layers”, or U.S. Pat. No. 6,742,453 to Borski, issued Jun. 1, 2004, entitled “Printing sleeves and methods for producing same”.

The photosensitive layer can contain a single monomer or mixture of monomers; in one embodiment including binder, all monomers are compatible with the predominant binder by weight to the extent that a clear, non-cloudy photosensitive layer is produced. Monomers that can be used in the photosensitive layer are well known in the art and include but are not limited to addition-polymerization ethylenically unsaturated compounds having relatively low molecular weights (generally less than about 30,000). Preferably, the monomers have a relatively low molecular weight less than about 5000. Examples of suitable monomers include, but are not limited to, t-butyl acrylate, lauryl acrylate, the acrylate and methacrylate mono-and poly-esters of alcohols and polyols such as alkanols, e.g., 1,4-butanediol diacrylate, 2,2,4-trimethyl-1,3 pentanediol dimethacrylate, and 2,2-dimethylolpropane diacrylate; alkylene glycols, e.g., tripropylene glycol diacrylate, butylene glycol dimethacrylate, hexamethylene glycol diacrylate, and hexamethylene glycol dimethacrylate; trimethylol propane; ethoxylated trimethylol propane; pentaerythritol, e.g., pentaerythritol triacrylate; dipentaerythritol; and the like. Other examples of suitable monomers include acrylate and methacrylate derivatives of isocyanates, esters, epoxides and the like, such as decamethylene glycol diacrylate, 2,2-di(p-hydroxyphenyl)propane diacrylate, 2,2-di(p-hydroxyphenyl)propane dimethacrylate, polyoxyethyl-2,2-di(p-hydroxyphenyl)propane dimethacrylate, and 1-phenyl ethylene-1,2-dimethacrylate. Preferred are compounds having two or more polymerizable groups.

One or more photoinitiators may be found in the photosensitive layer. The photoinitiator can be any single compound or combination of compounds which is sensitive to actinic radiation, generating one or more free radicals which initiate the polymerization of the monomer or monomers without excessive termination. The photoinitiator is generally sensitive to actinic light, e.g., visible or ultraviolet radiation, preferably ultraviolet radiation. Preferably, the photoinitiator should be thermally inactive at and below 185° C.

For the purposes of this invention, one class of useful photoinitiators are those characterized by being photoreducible, although other photoinitiators well known in photosensitive layers of flexographic print sleeves are also suitable. Photoreducible photoinitiators are compounds which absorb actinic light very strongly and thus become activated to the point where they will abstract hydrogen atoms from compounds which are hydrogen donors, including binder and monomer. By so doing, the photoinitiator is itself reduced and the hydrogen donor is converted into a free radical. Representative compounds are benzophenone, 2-chlorobenzophenone, 4-methoxybenzophenone, 4-methylbenzophenone, 4,4′-dimethylbenzophenone, 4-bromobenzophenone, 2,2′,4,4′-tetrachlorobenzophenone, 2-chloro-4′-methylbenzophenone, 4-chloro-4′-methylbenzophenone, 3-methylbenzophenone, 4-tert-butylbenzophenone, benzoin, benzoin methyl ether, benzoin ethyl ether, benzoin isopropyl ether, benzoin isobutyl ether, benzoin acetate, benzil, benzilic acid, methylene blue, acetophenone, 2,2-diethoxyacetophenone, 9,10-phenanthrenequinone, 2-methyl anthraquinone, 2-ethylanthraquinone, 2-tert-butylanthraquinone, and 1,4-naphthoquinone. Particularly suitable are 2,2-diethoxyacetophenone, 2,2-dimethoxy-2-phenylacetophenone, benzoin isopropyl ether, benzoin isobutyl ether, and 2-ethyl anthraquinone. Also applicable are combinations of carbonyl sensitizer compounds and certain organic amine activators as disclosed in U.S. Pat. No. 3,759,807 to Trecker et al., issued Sep. 18, 1973, entitled “PHOTOPOLYMERIZATION PROCESS USING COMBINATIONS OF ORGANIC CARBONYLS AND AMINES”. The amount of such compounds can be from about 0.05% to about 10%, more preferably from about 0.1% to about 5% by weight based on the weight of the binder in the photosensitive layer.

The binder of the photosensitive layer is typically a natural or artificial polymer, from a molecular weight predominantly of about 1000 to 1,000,000 atomic mass units, as is well known in the art. The binder can used to optimize the viscosity of the photosensitive layer (generally by thickening to an easily handled, “dry” state), it may chemically change during exposing (e.g. by ablation, chain-transfer reactions, or photocrosslinking), and it may affect development properties (e. g. by virtue of carboxylate groups). Suitable binders are polyalkadienes, alkadiene/acrylonitrile copolymers; ethylene/propylene/alkadiene copolymers; ethylene/(meth)acrylic acid/(meth)acrylate ester copolymers, polystyrene-isoprene-styrene, and polystyrene-butadiene-styrene, especially block co-polymers.

In one embodiment, the binder can be soluble, swellable or dispersible in aqueous, semi-aqueous or organic solvent developers. Binders which are soluble, swellable or dispersible in organic solvent developers include natural or synthetic polymers of conjugated diolefin hydrocarbons, including polyisoprene, 1,2-polybutadiene, 1,4-polybutadiene, butadiene/acrylonitrile, butadiene/styrene thermoplastic-elastomeric block copolymers and other copolymers. It is preferred that the binder be present in at least an amount of 50% by weight of the photosensitive layer. The term binder, as used herein, encompasses core shell microgels and blends of microgels and preformed macromolecular polymers, such as those disclosed in U.S. Pat. No. 4,956,252 to Fryd et al., issued Sep. 11, 1990, entitled “Aqueous processible photosensitive compositions containing core shell microgels”.

Particularly suitable binders for the layer are elastomeric binders. However, it is in principle also possible to employ non-elastomeric binders. It is useful Q_{F} the final relief layer has elastomeric properties. The final relief layer may, for example, take on elastomeric properties through the use of plasticizers, or it is also possible to employ a crosslinkable oligomer as monomer, which may form an elastomeric network through polymerization.

Suitable elastomeric binders for the photosensitive layer are, in particular, polymers which comprise 1,3-diene monomers, such as isoprene or butadiene. Examples which may be mentioned are natural rubber, polyisoprene, styrene-butadiene rubber, nitrile-butadiene rubber, butyl rubber, styrene-isoprene rubber, polynorbornene rubber or ethylene-propylene-diene rubber (EPDM). However, it is also in principle possible to employ ethylene-propylene, ethylene-acrylate, ethylene-vinyl acetate or acrylate rubbers. Also suitable are hydrogenated rubbers or elastomeric polyurethanes.

It is also possible to employ modified binders in which crosslinkable groups are introduced into the polymeric molecule binder by grafting reactions.

Particularly suitable elastomeric binders are thermoplastic elastomeric block copolymers comprising alkenylaromatic compounds and 1,3-dienes. The block copolymers can be either linear block copolymers or free-radical block copolymers. They are usually three-block copolymers of the A-B-A type, but can also be two-block copolymers of the A-B type, or those comprising a plurality of alternating elastomeric and thermoplastic blocks, for example A-B-A-B-A. It is also possible to employ mixtures of two or more different block copolymers. Commercially available three-block copolymers frequently comprise certain proportions of two-block copolymers. The diene units may be 1,2-or 1,4-linked. They may also be fully or partially hydrogenated. It is possible to employ both block copolymers of the styrene-butadiene and of the styrene-isoprene type. They are commercially available, for example under the name KRATON. It is furthermore possible to employ thermoplastic-elastomeric block copolymers having end blocks of styrene and a random styrene-butadiene central block.

The type and amount of binder employed are selected by the person skilled in the art depending on the desired properties of the final relief layer of the flexographic extended print sleeve. In general, an amount of from 50 to 95% by weight of binder, based on the amount of all constituents of the photosensitive layer, has proven successful. It is also possible to employ mixtures of different binders.

In one embodiment, the extended print sleeve is exposed to actinic radiation; the exposure can be over practically all areas of the photosensitive layer; or a selective, imagewise exposure.

Actinic radiation is radiation that acts to photopolymerize the photosensitive layer by starting reactions of the photoinitiator that polymerize the monomer. Actinic radiation may have wavelengths of 200 to 800 nanometers. Some practical sources of such actinic radiation include carbon arc lamps, super high pressure mercury lamps, high pressure mercury lamps, low pressure mercury lamps, xenon lamps, ultra violet fluorescent lamps and sunlight.

The exposing may be done through a mask that is integral to the extended print sleeve (e.g. an actinic radiation blocking, selectively laser responsive layer as mask) or separable (conventional reusable masks known as phototools); or without a mask (to be later followed by laser engraving leaving a relief).

The direction of the exposing to actinic radiation can be from the outside of the photosensitive layer towards the cylindrically-shaped support, or in the opposite direction. In one embodiment, exposing from the hollow center of the extended print sleeve towards the photosensitive layer can be used to establish a “floor”; in this embodiment an overall exposure may be used, and it is preferred if the concentric layers under the photosensitive layer are not opaque to the actinic radiation (e.g. a cylindrically-shaped support of polyester is preferred to one of nickel).

After exposing to actinic radiation, the exposed extended print sleeve can be treated in a number of conventional ways to form a relief surface suitable for printing, including removal by a washout liquid, heating and removing the hot unexposed photosensitive layer (both taking advantage of different properties between exposed and unexposed regions of the photosensitive layer) and engraving.

Washout takes advantage of selective removal by a washout liquid of unexposed regions of photosensitive layer than regions of polymerized, actinic-radiation-exposed, photosensitive layer. Following exposure to actinic radiation through the mask, the extended print sleeve is treated by washing with a liquid or gel comprising a suitable washout liquid. The washout liquid can constitute all of the washing liquid, or can be the continuous phase or discontinuous phase of an emulsion washing liquid or latex washing liquid.

Processing with a washout liquid is usually carried out at about room temperature or with mild heating, for example to 42° C. The washout liquid can be solvent, organic, water, aqueous or semi-aqueous solution. The choice of the washout liquid will depend on the chemical nature of the material to be removed. Suitable solvent washout liquids include aromatic or aliphatic hydrocarbons, halocarbons, halohydrocarbons, esters, alcohols, ethers, or mixtures of such, or other washout solvent liquids known in the art. Other organic washout liquids have been disclosed in published German Application 3 828 551 and in U.S. Pat. No. 5,354,645 to Schober et al., issued Oct. 11, 1994, entitled “Process for the production of flexographic printing reliefs”. Suitable semi-aqueous washout liquids usually contain water and a water miscible organic solvent and an alkaline material. Suitable aqueous washout liquids usually contain water and an alkaline material. Other suitable aqueous combinations are described in U.S. Pat. No. 6,506,542 to Kraska, et al. issued Jan. 14, 2003, entitled “Developer and process for preparing flexographic printing forms” and U.S. Pat. No. 6,537,731 to Kraska, et al. issued Mar. 25, 2003, entitled “Developer and process for preparing flexographic printing forms”. Suitable alkaline materials include potassium hydroxide, potassium carbonate, and tetramethylammonium hydroxide.

Development time can vary, but it is preferably in the range of about 2 to 25 minutes. Developer can be applied in any convenient manner, including immersion, spraying and brush or roller application. Brushing aids can be used to remove the unexposed portions of the photosensitive layer. However, washout is frequently carried out in an automatic processing unit which uses developer and mechanical brushing action to remove the unexposed portions of the exposed extended printing sleeve, leaving a relief.

Following washout, the extended relief print sleeve is generally blotted or wiped dry, and then dried in a forced air or infrared oven. Drying times and temperatures may vary, however, typically the extended relief print sleeve could be dried for 60 to 120 minutes at 60° C.

Another conventional treating step of the extended print sleeve to form a relief surface suitable for printing is heating the extended print sleeve to a temperature sufficient to cause unpolymerized (unexposed) portions of the photosensitive layer to melt, flow, or soften, and removing the unpolymerized (unexposed) portions. Temperatures of 40-200° C. are typically used. In one embodiment, an absorbent material can be used to wick away the unpolymerized (unexposed) material. Apparatus suitable for thermal development of photosensitive printing elements is disclosed in U.S. Pat. No. 5,279,697 to Peterson et al., issued Jan. 18, 1994, entitled “Device for forming flexographic printing plate” and U.S. Pat. No. 6,797,454 to Johnson et al., issued Sep. 28, 2004, entitled “Method and apparatus for thermal processing a photosensitive element”.

Another conventional treating step of the extended print sleeve to form a relief surface suitable for printing is engraving the extended print sleeve with laser radiation to selectively remove portions of the photosensitive layer, preferably the exposed photosensitive layer. In one embodiment, the extended print sleeve is overall exposed to radiation, particularly actinic radiation, more particularly ultraviolet radiation. This serves to partially or completely polymerize the monomers in the photosensitive layer, particularly when the layer comprises a photoinitiator, and strengthen the photosensitive layer. The strengthened photosensitive layer is particularly suitable for laser engraving to remove portions of the photosensitive layer which should not be printed, thereby forming a relief.

U.S. Pat. No. 5,798,202 to Cushner et al., issued Aug. 25, 1998, entitled “Laser engravable single-layer flexographic printing element”, and U.S. Pat. No. 6,737,216 to Kannurpatti et al., issued May 18, 2004, entitled “Laser engravable flexographic printing element and a method for forming a printing plate from the element” disclose suitable and adaptable processes for making a relief on an extended print sleeve or a suitably analogous flexographic printing plate by laser engraving an exposed photosensitive layer or analogous reinforced elastomeric layer on a support.

What is claimed is:

1. An extended print sleeve having a longitudinal axis and adapted to form a printing form having a circumferential seam with no printing surface disposed a distance D along said longitudinal axis from one end thereof, comprising:
a first print element; and
a second print element;
wherein each print element comprises a separate cylindrically-shaped support having a photosensitive layer thereon and disposed at a fixed position along said longitudinal axis, and wherein said second print element has a length substantially equal to distance D.

2. The print sleeve of claim 1 wherein both said first and said second print elements are fastened to a base support sleeve.

3. The print sleeve of claim 2 wherein at least one of said print elements is fastened to said base support sleeve by an interference fit.

4. The print sleeve of claim 2 wherein at least one of said print elements is fastened to said base support sleeve by an adhesive.

5. The print sleeve of claim 2 wherein at least one of said print elements is fastened to said base support sleeve by a weld.

6. The print sleeve of claim 2 wherein at least one of said print elements is fastened to said base support sleeve by a mechanical connector.

7. The print sleeve of claim 2 wherein said first print element is spatially separated from said second print element.

8. The print sleeve of claim 2 wherein said first print element contacts said second print element.

9. The print sleeve of claim 1 wherein said first print element is joined at one end thereof to an end of said second print element.

10. The print sleeve of claim 9 wherein said first and said second print elements are joined by attaching said cylindrically-shaped supports together end to end thereof.

11. The print sleeve of claim 1 wherein said first print element has a length substantially equal to distance D, whereby said extended print sleeve has a length equal to 2D.

12. The print sleeve of claim 1 wherein said first print element has a maximum length equal to 2D, whereby said extended print sleeve has a length equal to 3D.

13. A method for making an extended print sleeve having a longitudinal axis and adapted to form a printing form having a circumferential seam with no printing surface disposed a distance D along said longitudinal axis from one end thereof comprising:
providing a first print element comprising a cylindrically-shaped support having a photosensitive layer thereon;
providing a second print element comprising a cylindrically-shaped support having a photosensitive layer thereon and a length substantially equal to distance D; and
placing said first and said second print elements at a fixed position end to end thereof along said longitudinal axis.

14. The method of claim 13 wherein said placing step is performed by fastening both said first and said second print elements to a base support sleeve.

15. The method of claim 14 wherein said first print element is spatially separated from said second print element.

16. The method of claim 14 wherein said first print element contacts said second print element.

17. The method of claim 13 wherein said placing step is performed by joining said first print element at one end thereof to an end of said second print element.

18. The method of claim 17 wherein said first and said second print elements are joined by attaching said cylindrically-shaped supports together end to end thereof.

19. A method for preparing a cylindrically-shaped printing form having a longitudinal axis and a circumferential seam with no printing surface disposed a distance D along said longitudinal axis from one end thereof comprising:
providing an extended print sleeve comprising
a first print element; and
a second print element;
wherein each print element comprises a separate cylindrically-shaped support having a photosensitive layer thereon and disposed at a fixed position along said longitudinal axis, wherein said second print element has a length substantially equal to distance D, and wherein each photosensitive layer comprises a binder, a monomer and a photoinitiator;
exposing the extended print sleeve to actinic radiation; and
treating the exposed extended print sleeve to form a relief surface suitable for printing.

20. The method of claim 19 wherein the exposing step is selected from the group consisting of (a) imagewise exposing through a mask to form polymerized portions and unpolymerized portions, and (b) overall exposing.

21. The method of claim 19 wherein the treating step is selected from the group consisting of:
(a) processing with a washout liquid selected from the group consisting of solvent solution, aqueous solution, semi-aqueous solution, and water;
(b) heating the extended print sleeve to a temperature sufficient to cause unpolymerized portions to melt, flow, or soften, and removing the unpolymerized portions; and
(c) engraving the extended print sleeve with laser radiation to selectively remove portions.
